(19) United States
(12) Patent Application Publication
(10) Pub. No.: US 2024/0327630 A1
(43) Pub. Date: Oct. 3, 2024

(54) POLYETHYLENE COPOLYMER FOR A FILM LAYER

(71) Applicant: BOREALIS AG, Vienna (AT)

(72) Inventors: Jingbo WANG, Linz (AT); Friedrich BERGER, Linz (AT); Jani AHO, Porvoo (FI)

(73) Assignee: BOREALIS AG, Vienna (AT)

(21) Appl. No.: 18/293,925

(22) PCT Filed: Aug. 4, 2022
(86) PCT No.: PCT/EP2022/071897

§ 371 Date: Jan. 31, 2024

(30) Foreign Application Priority Data
Aug. 6, 2021 (EP) 21190020.4

(51) Int. Cl. C08L 23/08; C08F 210/02; C08J 5/18

(52) U.S. Cl. CPC C08L 23/0807; C08F 210/02; C08J 5/18; C08J 2323/08; C08J 2423/08; C08L 2205/025

(57) ABSTRACT

The present disclosure relates to a metallocene-catalysed multimodal polyethylene copolymer, to the use of the multimodal copolymer of ethylene in film applications and to a film including the polymer composition.

The present invention relates to a metallocene-catalysed multimodal polyethylene copolymer (P), to the use of the multimodal polyethylene copolymer (P) in film applications and to a film comprising the polymer composition of the invention.

Unimodal polyethylene (PE) polymers, for instance SSC products, are usually used for film applications. Unimodal PE polymers have for instance good optical properties, like low haze, but for instance, the melt processing of such polymers is not satisfactory in production point of view and may cause quality problems of the final product as well. Multimodal PE polymers with two or more different polymer components are better to process, but e.g. melt homogenisation of the multimodal PE may be problematic resulting in inhomogeneous final products evidenced e.g. by high gel content of the final product.

It is known in the field of polyolefin production that in particular in polymerization processes in which bi- or multimodal compositions are produced, the particle size of the polymer powder leaving the last reactor is a key feature.

In the case of multimodal polyethylenes produced in at least two reactors, it is often found that the largest particles exiting the final polymerization reactor consist mainly of polymer made in the reactor producing the highest molecular weight fraction (e.g. this is usually the second reactor in a bimodal reaction). A problem with particularly large particles is that they may require longer to be fully compounded in an extruder than the residence time of the extruder; thus they exit the extruder as inhomogeneities in the compounded product, which can lead to gels or white spots.

Multimodal polyethylenes are inherently difficult to homogenize due to a large difference in viscosities and a large difference in particle size of the various reactor powder particles.

Especially in sequential polymerization processes, the high molecular weight and high viscous powder particles are normally considerably larger than the lower molecular weight particles.

Such large particles can furthermore be caused be agglomeration.

Multimodal mLLDPEs are known in the art.

WO 2021/009189 A, WO 2021/009190 A and WO 2021/009191 A of Borealis disclose a process for preparing multimodal PE polymers in two loop reactors and one gas phase reactor in the presence of a silica supported metallocene catalyst based on the metallocene complex bis(1-methyl-3-n-butylcyclopentadienyl) zirconium (IV) dichloride.

The polymers produced in the Examples have a total density of 938 or 939 kg/m³. The MFR₂ (190° C., 2.16 kg, ISO 1133) of the polymer components produced in the first loop reactor is about 22 or 23 g/10 min. The MFR₂ (190° C., 2.16 kg, ISO 1133) of the polymer components after the second loop reactor not more than 31 g/10 min.

Also WO 2021/009192 A discloses such a process. The polymer produced in the Examples has an even higher density of 951 kg/m³. The MFR₂ (190° C., 2.16 kg, ISO 1133) of the polymer component produced in the first loop is 32 g/10 min. The MFR₂ (190° C., 2.16 kg, ISO 1133) of the polymer components after the second loop reactor not more than 22 g/10 min.

None of these patent applications describes the particle size distribution of the polymer power leaving the gas phase reactor.

There is a continuous need to find multimodal PE polymers with less tendency to agglomerate in powder form and/or with less amount of larger polymer particles, as these can lead to problems, particularly with the final product or during polymerization due to plugging of the plant.

Therefore, it is an object of the present invention to provide a multimodal polyethylene composition having improved homogeneity directly after its production, less tendency to agglomerate in powder form and/or reduced amount of very large particles (i.e. particles with a particle size of above 710 μm) in the polymer powder.

### DESCRIPTION OF THE INVENTION

The present invention is therefore directed to a metallocene-catalysed multimodal polyethylene copolymer (P) in powder form, which consists of
(i) 30.0 to 70.0 wt % of an ethylene polymer component (A), and
(ii) 70.0 to 30.0 wt % of an ethylene polymer component (B),
whereby the ethylene polymer component (A) has
   a density in the range of from 925 to 960 kg/m³,
   an MFR₂ (190° C., 2.16 kg, ISO 1133) in the range of from 10.0 to 300.0 g/10 min,
   wherein the ethylene polymer component (A) consists of an ethylene polymer fraction (A-1) and (A-2),
the ethylene polymer component (B) has
   a density in the range of from 880 to 915 kg/m³,
   an MFR₂ (190° C., 2.16 kg, ISO 1133) in the range of from 0.001 to 1.0 g/10 min
whereby the multimodal polyethylene copolymer (P) has
   a density in the range of from 905 to 916 kg/m³,
   an MFR₂ (190° C., 2.16 kg, ISO 1133) in the range of from 0.1 to 3.0 g/10 min,
   a ratio of the MFR₂₁ (190° C., 21.6 kg, ISO 1133) to MFR₂ (190° C., 2.16 kg, ISO 1133),
   MFR₂₁/MFR₂, in the range of from 33.0 to 80.0 and
   a ratio of the MFR₂ (190° C., 2.16 kg, ISO 1133) of the ethylene polymer component (A) to the MFR₂ (190° C., 2.16 kg, ISO 1133) of the multimodal polyethylene copolymer (P), MFR₂ (A)/MFR₂ (P), in the range of 7.5 to 200.0.

In an embodiment of the present invention, the ethylene polymer component (A) of the metallocene-catalysed multimodal polyethylene copolymer (P) consists of an ethylene polymer fraction (A-1) and an ethylene polymer fraction (A-2), wherein the density of fractions (A-1) and (A-2) is in the range of from 925 to 960 kg/m³ and the MFR₂ (190° C., 2.16 kg, ISO 1133) is in the range of from 10.0 to 300 g/10 min and wherein the density and/or the MFR₂ (190° C., 2.16 kg, ISO 1133) of ethylene polymer fractions (A-1) and (A-2) may be the same or may be different.

Unexpectedly the multimodal polyethylene copolymer (P) of the invention in powder form (i.e. taken directly from the reactor after the final polymerization step) has less particles with a particle size of above 710 μm.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed multimodal polyethylene copolymer is defined in this invention as multimodal polyethylene copolymer (P), which has been produced in the presence of a metallocene catalyst.

Term “multimodal” in context of multimodal polyethylene copolymer (P) means herein multimodality with respect to melt flow rate (MFR) of the ethylene polymer components (A) and (B) as well as ethylene polymer fraction (A-1) and (A-2), i.e. the ethylene polymer components (A) and (B), as well as fractions (A-1) and (A-2) have different MFR values. The multimodal polyethylene copolymer (P) can have further multimodality with respect to one or more further properties between the ethylene polymer components (A) and (B) as well as between fractions (A-1) and (A-2), as will be described later below.

The multimodal polyethylene copolymer (P) of the invention as defined above, below or in claims is also referred herein shortly as “multimodal PE” or “multimodal copolymer (P)”.

The multimodal polyethylene copolymer (P) of the invention as defined above, below or in claims is the polymer taken from the reactor after the final polymerization step and is thus in powder form (before pelletization).

The multimodal polyethylene copolymer (P) in powder form can be further combined with additives with subsequent pelletization, yielding multimodal polyethylene copolymer (P′) in pellet form.

The following preferable embodiments, properties and subgroups of multimodal PE and the ethylene polymer components (A) and (B) thereof, as well as the ethylene polymer fractions (A-1) and (A-2) and the film of the invention including the preferable ranges thereof, are independently generalisable so that they can be used in any order or combination to further define the preferable embodiments of the multimodal PE and the article of the invention.

### Multimodal PE as Well as Ethylene Polymer Component (A) and (B) and Ethylene Polymer Fractions (A-1) and (A-2)

The metallocene produced multimodal polyethylene copolymer (P) is referred herein as “multimodal”, since the ethylene polymer component (A), including ethylene polymer fractions (A-1) and (A-2), and ethylene polymer component (B) have been produced under different polymerization conditions resulting in different Melt Flow Rates (MFR, e.g. MFR₂). I.e. the multimodal PE is multimodal at least with respect to difference in MFR of the ethylene polymer components (A) and (B).

The metallocene produced multimodal polyethylene copolymer (P) consists of
(i) 30.0 to 70.0 wt % of an ethylene polymer component (A), and
(ii) 70.0 to 30.0 wt % of an ethylene polymer component (B).

The amount of (A) and (B) add up to 100.0 wt %.

The ethylene polymer component (A) consists of an ethylene polymer fraction (A-1) and (A-2).

The ethylene polymer component (A) and the ethylene polymer (B) are preferably a copolymer of ethylene and a comonomer being selected from C₄ to C₁₂ α-olefins, more preferably C₄ to C₈ α-olefins and yet more preferably C₄ to C₆ α-olefins.

Preferably, the comonomer of ethylene polymer component (A) is different from the comonomer of ethylene polymer component (B).

In an embodiment of the present invention, the ethylene polymer component (A) is, thus an ethylene-1-butene polymer and the ethylene polymer component (B) is an ethylene-1-hexene polymer.

The MFR₂ of the ethylene polymer fractions (A-1) and (A-2) may be different from each other or may be the same.

The ethylene polymer fractions (A-1) and (A-2) have an MFR₂ (190° C., 2.16 kg, ISO 1133) in the range of 10.0 to 300.0 g/10 min, preferably of 15.0 to 250.0 g/10 min, more preferably of 20.0 to 200.0 g/10 min, even more preferably of 25.0 to 150.0 g/10 min and yet more preferable from 30.0 to 100.0 g/10 min.

The MFR₂ of the ethylene polymer components (A) and (B) are different from each other.

The ethylene polymer component (A) has a MFR₂ (190° C., 2.16 kg, ISO 1133) in the range of 10.0 to 300.0 g/10 min, preferably of 20.0 to 250.0 g/10 min, more preferably of 30.0 to 200.0 g/10 min and even more preferably of 35.0 to 100.0 g/10 min.

The ethylene polymer component (B) has a MFR₂ (190° C., 2.16 kg, ISO 1133) in the range of 0.001 to 1.0 g/10 min, preferably of 0.002 to 0.9 g/10 min, more preferably of 0.003 to 0.8 g/10 min, even more preferably of 0.005 to 0.7 g/10 min and yet more preferably of 0.01 to 0.5 g/10 min.

The MFR₂ (190° C., 2.16 kg, ISO 1133) of the multimodal copolymer (P) is in the range of 0.1 to 3.0 g/10 min, preferably 0.2 to 2.5 g/10 min, more preferably 0.4 to 2.0 g/10 min and even more preferably 0.5 to 1.8 g/10 min.

The multimodal copolymer (P) has a ratio of the MFR₂₁ (190° C., 21.6 kg, ISO 1133) to MFR₂ (190° C., 2.16 kg, ISO 1133), MFR₂₁/MFR₂, in the range of from 33.0 to 80.0, preferably from 34.0 to 60.0, more preferably from 35.0 to 45.0.

Furthermore the ratio of the MFR₂ (190° C., 2.16 kg, ISO 1133) of the ethylene polymer component (A), preferably ethylene-1-butene-polymer component (A), to the MFR₂ (190° C., 2.16 kg, ISO 1133) of the final multimodal copolymer (P) is at least 7.5 to 200.0, preferably 15.0 to 150.0, more preferably of 20.0 to 100.0 and yet more preferably 25.0 to 50.0.

Naturally, in addition to multimodality with respect to, i.e. difference between, the MFR₂ of ethylene polymer components (A) and (B), the multimodal PE of the invention can also be multimodal e.g. with respect to one or both of the two further properties:
multimodality with respect to, i.e. difference between,
   the comonomer type and/or content(s) present in the ethylene polymer components (A) and (B); and/or
   the density of the ethylene polymer components (A) and (B).

Preferably, the multimodal copolymer (P) is further multimodal with respect to the comonomer type of the ethylene polymer components (A) and (B).

As stated above, in a preferred embodiment of the present invention, the ethylene polymer component (A) is an ethylene-1-butene polymer and the ethylene polymer component (B) is an ethylene-1-hexene polymer.

The comonomer type for the polymer fractions (A-1) and (A-2) is the same, thus preferably both fractions therefore have 1-butene as comonomer.

Even more preferably the multimodal polymer (P) of the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of 925 to 960 kg/m³, preferably of 930 to 950 kg/m³, more preferably 935 to 945 kg/m³ and/or the density of the ethylene polymer component (B) is of in the range of 880 to 915 kg/m³, preferably of 885 to 910 kg/m³ and more preferably of 890 to 905 kg/m³.

The polymer fractions (A-1) and (A-2) have a density in the range of from 925 to 960 kg/m³, preferably of 928 to 955 kg/m³, more preferably of 930 to 950 kg/m³, and most preferred 935 to 945 kg/m³.

The density of polymer fraction (A-1) and (A-2) may be the same or may be different from each other.

The metallocene catalysed multimodal copolymer (P) is preferably a linear low density polyethylene (LLDPE) which has a well known meaning.

The density of the multimodal copolymer (P) is in the range of 905 to 916 kg/m³, preferably of 908.0 to 915 kg/m³ and more preferably of 910.0 to 915.0 kg/m³.

More preferably the multimodal copolymer (P) is multimodal at least with respect to, i.e. has a difference between, the MFR₂, the comonomer type as well as with respect to, i.e. has a difference between the density of the ethylene polymer components, (A) and (B), as defined above, below or in the claims including any of the preferable ranges or embodiments of the polymer composition.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 30.0 to 70.0 wt % based on the multimodal copolymer (P), preferably in an amount of 32.0 to 55.0 wt % and even more preferably in an amount of 34.0 to 45.0 wt %.

Thus, the ethylene polymer component (B) is present in an amount of 70.0 to 30.0 wt % based on the multimodal copolymer (P), preferably in an amount of 68.0 to 45.0 wt % and more preferably in an amount of 66.0 to 55.0 wt %.

The metallocene catalysed multimodal copolymer (P) is in powder form, since taken directly from the reactor after the final polymerization step.

The multimodal copolymer (P) has less particles with a particle size of above 710 μm, i.e. the amount of particles, based on the overall amount of particles, with a particle size of above 710 μm is below 6.0 wt %, preferably 0.1 to 5.0 wt %, more preferably 0.3 to 4.0 wt %, even more preferably 0.5 to 3.0 wt % and yet more preferably 0.5 to 2.0 wt %.

The particle size being determined by sieving analysis according to ASTM 1921.

In an embodiment of the invention, the multimodal copolymer (P) preferably has a span of the particle size distribution of polymer particles of below 1.40, more preferably below 1.30 and most preferably below 1.15. The lower limit of the particle size distribution is suitably 0.5.

Particle size distribution (PSD) defined by SPAN: Span=(D90−D10)/D50 is determined by laser diffraction measurements by Coulter LS 200 according to ISO 13320.

The multimodal copolymer (P) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273, WO 2021009189, WO 2021009190, WO 2021009191 and WO 2021009192. Full details of how to prepare suitable metallocene catalysed multimodal copolymer (P) can be found in these references.

A suitable process is the Borstar PE process or the Borstar PE 3G process.

The metallocene catalysed multimodal copolymer (P) according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal copolymer (P). This can counted as part of the first ethylene polymer component (A).

### Catalyst

The metallocene catalysed multimodal copolymer (P) used in the process of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

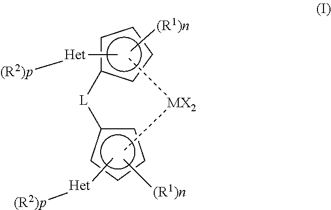

wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S;
L is-R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure (I)

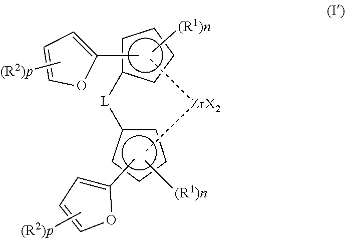

wherein each X is independently a halogen atom, a C₁₋₆-alkyl, C₁₋₆-alkoxy group, phenyl or benzyl group;
L is a Me₂Si;
each R′ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) respectively (I′) are

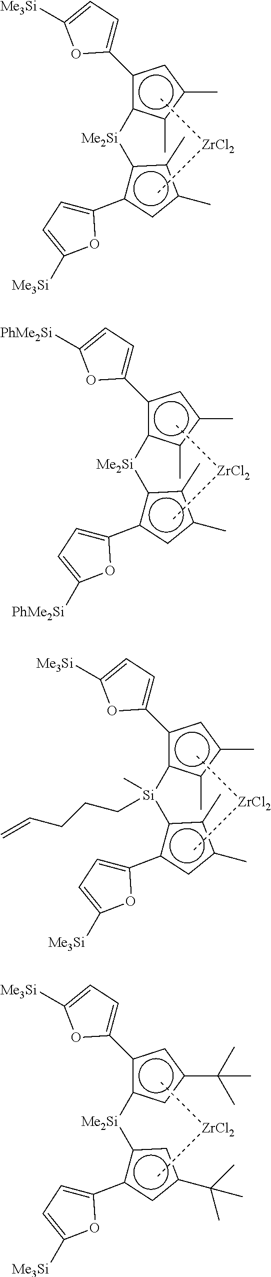

Most preferably the complex dimethylsilanediylbis[2-(5-trimethylsilylfuran-2-yl)-4,5-dimethylcyclopentadien-1-yl] zirconium dichloride is used.

More preferably the ethylene polymer components (A) and (B) of the multimodal copolymer (P) are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred. Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

After the metallocene catalysed multimodal copolymer (P) has been collected in powder form after the last reactor of the polymerization process, i.e. after the gas phase reactor, the powder can be combined with further polymer components and/or additives and/or fillers with subsequent pelletization, to yield multimodal copolymer (P′) in pellet form. In case the metallocene catalysed multimodal copolymer (P) is compounded with further polymer components, then the amount of the further polymer component(s) typically varies between 3.0 to 20.0 wt % based on the combined amount of the metallocene catalysed multimodal copolymer (P) and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so-called master batch, which comprises the respective additive(s) together with a carrier polymer. In such case the carrier polymer is not calculated to the polymer components of the metallocene catalysed multimodal copolymer (P), but to the amount of the respective additive(s), based on the total amount of polymer composition (100 wt %).

The multimodal copolymer (P′) in pellet form can be used for making films.

### Film of the Invention

The film of the invention comprises at least one layer comprising the metallocene catalysed multimodal copolymer (P′) in pellet form. The film can be a monolayer film comprising the metallocene catalysed multimodal copolymer (P′) or a multilayer film, wherein at least one layer comprises the metallocene catalysed multimodal copolymer (P′). The terms “monolayer film” and multilayer film” have well known meanings in the art.

The layer of the monolayer or multilayer film of the invention may consist of the metallocene catalysed multimodal copolymer (P′) as such or of a blend of the metallocene catalysed multimodal copolymer (P′) together with further polymer(s). In case of blends, any further polymer is different from the metallocene catalysed multimodal copolymer (P′) and is preferably a polyolefin. Part of the above mentioned additives, like processing aids, can optionally added to the metallocene catalysed multimodal copolymer (P) during the film preparation process.

Preferably, the at least one layer of the invention comprises at least 50 wt %, more preferably at least 60 wt %, even more preferably at least 70 wt %, yet more preferably at least 80 wt %, of the metallocene catalysed multimodal copolymer (P′) of the invention. Most preferably said at least one layer of the film of invention consists of the metallocene catalysed multimodal copolymer (P′).

Accordingly, the films of the present invention may comprise a single layer (i.e. monolayer) or may be multilayered. Multilayer films typically, and preferably, comprise at least 3 layers.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired. Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

The resulting films may have any thickness conventional in the art. The thickness of the film is not critical and depends on the end use. Thus, films may have a thickness of, for example, 300 μm or less, typically 6 to 200 μm, preferably 10 to 180 μm, e.g. 20 to 150 μm or 20 to 120 μm. If desired, the polymer of the invention enables thicknesses of less than 100 μm, e.g. less than 50 μm. Films of the invention with thickness even less than 20 μm can also be produced whilst maintaining good mechanical properties.

Furthermore, the present invention is also directed to the use of the inventive article as packing material, in particular as a packing material for food and/or medical products.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is determined at 190° C. for polyethylene. MFR may be determined at different loadings such as 2.16 kg (MFR₂), 5 kg (MFR₅) or 21.6 kg (MFR₂₁).

### Calculation of MFR₂ of Component B and of Fraction (A-2)

log A=x·log B+(1−x)·log C

$$C = {10}^{∧ \frac{( logA - x \cdot logB )}{( 1 - x )}}$$

### For Component B:

B=MFR₂ of Component (A)
C=MFR₂ of Component (B)
A=final MFR₂ (mixture) of multimodal polyethylene copolymer (P)
X=weight fraction of Component (A)

### For Fraction (A-2):

B=MFR₂ of 1^{st} fraction (A-1)
C=MFR₂ of 2^{nd} fraction (A-2)
A=final MFR₂ (mixture) of loop polymer (=Component (A))
X=weight fraction of the 1st fraction (A-1)

### Density

Density of the polymer was measured according to ASTM; D792, Method B (density by balance at 23° C.) on compression moulded specimen prepared according to EN ISO 1872-2 and is given in kg/m³.

### Particle Size

A sieve analysis according to ASTM 1921 was performed. The sieve analysis involved a nested column of sieves with wire mesh screen with the following sizes:
>20 μm, >32 μm, >63 μm, >100 μm, >125 μm, >160 μm, >200 μm, >250 μm, >315 μm, >400 μm, >500 μm, >710 μm, >1 mm, >1.4 mm, >2 mm, >2.8 mm, >4 mm.

The samples were poured into the top sieve which has the largest screen openings. Each lower sieve in the column has smaller openings than the one above (see sizes indicated above). At the base is the receiver. The column was placed in a mechanical shaker. The shaker shook the column. After the shaking was completed the material on each sieve was weighed. The weight of the sample of each sieve was then divided by the total weight to give a percentage retained on each sieve.

### Particle Size Distribution

was determined by laser diffraction measurements by Coulter LS 200

The particle size and particle size distribution is a measure for the size of the particles. The D-values (D10 (or d10), D50 (or d50) and D90 (or d90)) represent the intercepts for 10%, 50% and 90% of the cumulative mass of sample. The D-values can be thought of as the diameter of the sphere which divides the sample's mass into a specified percentage when the particles are arranged on an ascending mass basis. For example the D10 is the diameter at which 10% of the sample's mass is comprised of particles with a diameter less than this value. The D50 is the diameter of the particle where 50% of a sample's mass is smaller than and 50% of a sample's mass is larger than this value. The D90 is the diameter at which 90% of the sample's mass is comprised of particles with a diameter less than this value. The D50 value is also called median particle size. From laser diffraction measurements according to ISO 13320 the volumetric D-values are obtained, based on the volume distribution.

The distribution width or span of the particle size distribution is calculated from the D-values D10, D50 and D90 according to the below formula:

Span=(D90−D10)/D50

Unless specifically otherwise defined, the percentage numbers used in the text below refer to percentage by weight.

### EXPERIMENTAL PART

### Cat. Example: Catalyst Preparation for IE1 and CE1 (CAT1)

### Loading of SiO2:

10 kg of silica (PQ Corporation ES757, calcined 600° C.) was added from a feeding drum and inertized in the reactor until O₂ level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Polymerization: Inventive Examples: Inventive Multimodal Polyethylene Copolymer (P) with 1-Butene and 1-Hexene Comonomers

Borstar pilot plant with a 3-reactor set-up (loop1-loop2-GPR 1) and a prepolymerization loop reactor.

The inventive multimodal copolymers (P) of example 1 (IE1) as well as of the comparative example (CE1) were produced by using the polymerization conditions as given in Table 1.

TABLE 1
Polymerization conditions

| | CE1 | IE1 |
|---|---|---|
| Prepoly reactor | | |
| Catalyst feed (g/h) | 36 | 29 |
| Temp. (° C.) | 50 | 50 |
| Press. (kPa) | 5621 | 5743 |
| C2 (kg/h) | 4 | 4 |
| H2(g/h) | 0.03 | 0.04 |
| C4 (g/h) | 78. | 101 |
| Split (wt %) | 3.7 | 3.4 |
| loop 1 Fraction (A-1) | | |
| Temp. (° C.) | 85 | 85 |
| Press. (kPa) | 5547 | 5219 |
| C2 conc. (mol %) | 3.8 | 3.4 |
| H2/C2 ratio (mol/kmol) | 0.47 | 0.82 |
| C4/C2 ratio (mol/kmol) | 40.6 | 61.9 |
| Split (wt %) | 18.4 | 17.8 |
| Density (kg/m3) of loop 1 material (fraction (A-1)) | 942.7 | 943 |
| MFR2 (g/10 min) of loop 1 material (fraction (A-1)) | 6.9 | 50 |
| loop 2 | | |
| Temp. (° C.) | 85 | 85 |
| Press. (kPa) | 5336 | 5330 |
| C2 conc. (mol %) | 3.9 | 4 |
| H2/C2 ratio (mol/kmol) | 0.4 | 0.7 |
| C4/C2 ratio (mol/kmol) | 28 | 44 |
| Split (wt %) | 21.2 | 20.5 |
| Density (kg/m3) after loop 2 (component (A)) | 941.3 | 940.1 |
| MFR2 (g/10 min) after loop 2 (component (A)) | 6.9 | 43 |
| MFR2 (g/10 min) of loop 2 material (fraction (A-2)) | 6.9 | 36.8 |
| Density (kg/m3) of loop 2 material (fraction (A-2)) | 939.8 | 936.9 |
| GPR | | |
| Temp. (° C.) | 75.0 | 75.0 |
| Press. (kPa) | 2000 | 2000 |
| H2/C2 ratio (mol/kmol) | 1.00 | 0.96 |
| C6/C2 ratio (mol/kmol) | 15.06 | 12.62 |
| Split (wt %) | 56.70 | 58.2 |
| MFR2 (g/10 min) of GPR material (Component (B)) | 0.2 | 0.1 |
| Density (kg/m3) of GPR material (Component (B)) | 889.6 | 895.3 |

The polymer powders received after the gas phase reactor have been analyzed accordingly and the results can be seen in Table 2.

TABLE 2
Material properties of inventive multimodal copolymer
(P) and comparative copolymer in powder form

| Material | CE1 | IE1 |
|---|---|---|
| MFR₂ (g/10 min) (final) | 1.0 | 1.3 |
| MFR₂₁ (g/10 min) | 32.8 | 47.1 |
| MFR₂₁/MFR₂ | 32.5 | 37.4 |
| MFR₂(A)/MFR₂(P) | 6.8 | 34.1 |
| Density (kg/m³) | 912 | 914 |
| particle size of above 710 μm (wt %) | 6.93 | 1.03 |
| D90 (μm) | 966.8 | 693.6 |
| D10 (μm) | 257.0 | 259.4 |
| D50 (μm) | 492.1 | 427.8 |
| SPAN D90-D10/D50 | 1.44 | 1.01 |

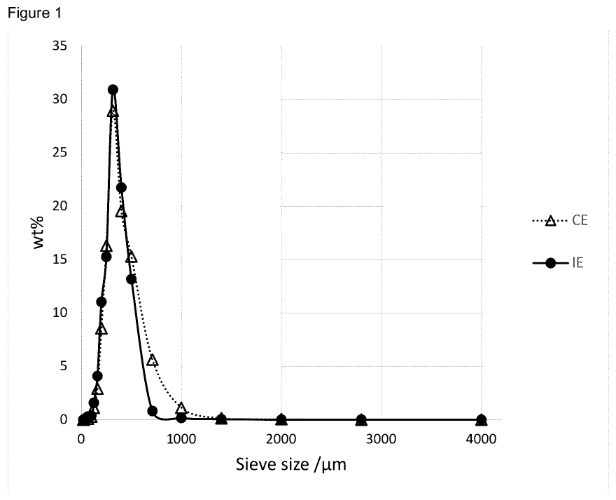

In FIG. 1 the particle size distribution of IE1 and CE1 obtained by sieving is shown. As can be seen there, the PSD curve for CE1 has a tailing, which is not seen for IE1.

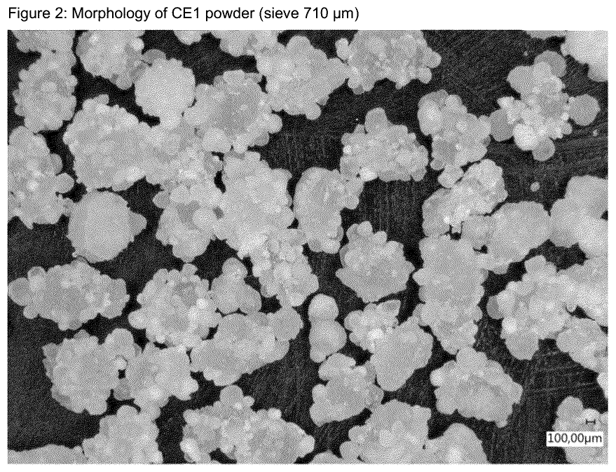

In FIG. 2 the morphology of CE1 powder (sieve 710 μm) is shown (optical microscope), whereby it can be seen that the ‘big particles’ are not a real grow up powder but rather agglomerates.

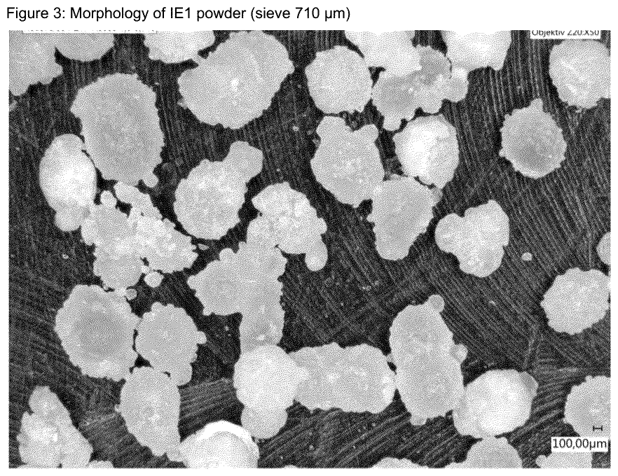

In comparison, FIG. 3 shows the morphology of IE1 powder (sieve 710 μm).

The improvement in view of particle size and PSD is due to the specific design of the inventive multimodal copolymer (P).

1-14. (canceled)

15. Metallocene-catalysed multimodal polyethylene copolymer (P) in powder form, which consists of:
(i) 30.0 to 70.0 wt % of an ethylene polymer component (A), and
(ii) 70.0 to 30.0 wt % of an ethylene polymer component (B),
whereby the ethylene polymer component (A) has:
a density in a range of from 925 to 960 kg/m³,
an MFR₂ (190° C., 2.16 kg, ISO 1133) in a range of from 10.0 to 300.0 g/10 min,
wherein the ethylene polymer component (A) consists of an ethylene polymer fraction (A-1) and (A-2),
whereby the ethylene polymer component (B) has:
a density in a range of from 880 to 915 kg/m³,
an MFR₂ (190° C., 2.16 kg, ISO 1133) in a range of from 0.001 to 1.0 g/10 min,
whereby the multimodal polyethylene copolymer (P) has:
a density in a range of from 905 to 916 kg/m³,
an MFR₂ (190° C., 2.16 kg, ISO 1133) in a range of from 0.1 to 3.0 g/10 min,
a ratio of MFR₂₁ (190° C., 21.6 kg, ISO 1133) to MFR₂ (190° C., 2.16 kg, ISO 1133), MFR₂₁/MFR₂, in a range of from 33.0 to 80.0, and
a ratio of the MFR₂ (190° C., 2.16 kg, ISO 1133) of the ethylene polymer component (A) to the MFR₂ (190° C., 2.16 kg, ISO 1133) of the multimodal polyethylene copolymer (P), MFR₂ (A)/MFR₂ (P), in a range of 7.5 to 200.0.

16. The composition according to claim 15, wherein a density of fractions (A-1) and (A-2) is in a range of from 925 to 960 kg/m³ and the MFR₂ (190° C., 2.16 kg, ISO 1133) is in a range of from 10.0 to 300 g/10 min, and wherein the density and/or the MFR₂ (190° C., 2.16 kg, ISO 1133) of ethylene polymer fractions (A-1) and (A-2) is the same or is different.

17. The composition according to claim 15, wherein the ethylene polymer component (A) and the ethylene polymer (B) are a copolymer of ethylene and a comonomer being selected from C₄ to C₁₂ α-olefins, and/or C₄ to C₈ α-olefins and/or C₄ to C₆ α-olefins;
the comonomer of ethylene polymer component (A) is different from the comonomer of ethylene polymer component (B), the ethylene polymer component (A) is an ethylene-1-butene polymer and the ethylene polymer component (B) is an ethylene-1-hexene polymer.

18. The metallocene-catalysed multimodal copolymer (P) according to claim 15, wherein
the ethylene polymer component (A) has a MFR₂ (190° C., 2.16 kg, ISO 1133) of 20.0 to 250.0 g/10 min, and/or of 30.0 to 200.0 g/10 min, and/or of 35.0 to 100.0 g/10 min, and
the ethylene polymer component (B) has a MFR₂ (190° C., 2.16 kg, ISO 1133) of 0.002 to 0.9 g/10 min, and/or of 0.003 to 0.8 g/10 min, and/or of 0.005 to 0.7 g/10 min.

19. The metallocene-catalysed multimodal copolymer (P) according to claim 15, wherein the ratio of the MFR₂₁ (190° C., 21.6 kg, ISO 1133) to MFR₂ (190° C., 2.16 kg, ISO 1133), MFR₂₁/MFR₂ is in a range of from 34.0 to 60.0, and/or from 35.0 to 45.0.

20. The metallocene-catalysed multimodal copolymer (P) according to claim 15, wherein the ratio of the MFR₂ (190° C., 2.16 kg, ISO 1133) of ethylene polymer component (A) to the MFR₂ (190° C., 2.16 kg, ISO 1133) of a final multimodal copolymer (P) is in a range of 15.0 to 150.0, and/or of 20.0 to 100.0, and/or of 25 to 50.

21. The metallocene-catalysed multimodal copolymer (P) according to claim 15, wherein the ethylene polymer component (A) is present in an amount of 32.0 to 55.0 wt % based on the multimodal copolymer (P) and in an amount of 34.0 to 45.0 wt % based on the multimodal copolymer (P), and
the ethylene polymer component (B) is present in an amount of 68.0 to 45.0 wt % based on the multimodal copolymer (P), and/or in an amount of 66.0 to 55.0 wt % based on the multimodal copolymer (P).

22. The metallocene-catalysed multimodal copolymer (P) according to claim 15, wherein the multimodal copolymer (P) is produced in a presence of metallocene complex of formula (I): 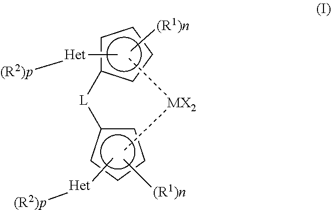
wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

23. The metallocene-catalysed multimodal copolymer (P) according to claim 15, wherein an amount of particles, based on an overall amount of particles, with a particle size of above 710 μm is below 6.0 wt %, and/or 0.1 to 5.0 wt %, and/or 0.3 to 4.0 wt %, and/or 0.5 to 3.0 wt %, and/or 0.5 to 2.0 wt %, a particle size being determined by sieve analysis according to ASTM 1921.

24. The metallocene-catalysed multimodal copolymer (P) according claim 15, wherein a particle size distribution (PSD) defined by SPAN: D90-D10/D50 is below 1.40, and/or below 1.30 and/or below 1.15, whereby the particle size distribution (PSD) defined by SPAN is determined by laser diffraction measurements by Coulter LS 200 according to ISO 13320.

25. The metallocene-catalysed multimodal copolymer (P) according to claim 15, wherein the metallocene-catalysed multimodal copolymer (P) in powder form is combined with further polymer components and/or additives and/or fillers with subsequent pelletization, to yield multimodal copolymer (P′) in pellet form.

26. Film comprising a metallocene-catalysed multimodal copolymer (P′) according to claim 25.

27. Film according to claim 26, wherein the film comprises:
at least one layer containing the metallocene-catalysed multimodal copolymer (P′), whereby the at least one layer of the film includes at least 50 wt %, and/or at least 60 wt %, and/or at least 70 wt %, and/or at least 80 wt %, of the metallocene catalysed multimodal copolymer (P).

28. Film according to claim 26, in combination as a packing material for food and/or medical products.
